(19) United States
(12) Patent Application Publication
(10) Pub. No.: US 2011/0159404 A1
(43) Pub. Date: Jun. 30, 2011

(54) Polyolefin Support to Prevent Dielectric Breakdown in PEMS

(75) Inventors: Timothy J. Fuller, Pittsford, NY (US); Steven R. Falta, Honeoye Falls, NY (US); Michael R. Schoeneweiss, W. Henrietta, NY (US); Sean M. Mackinnon, Fairport, NY (US)

(73) Assignee: GM GLOBAL TECHNOLOGY OPERATIONS, INC., DETROIT, MI (US)

(21) Appl. No.: 12/648,720

(22) Filed: Dec. 29, 2009

(51) Int. Cl. H01M 8/10

(52) U.S. Cl. 429/492; 429/494

(57) ABSTRACT

A fuel cell includes a first catalyst layer and a second catalyst layer. An ion conducting membrane is interposed between the first and second catalyst layers. The ion conducting layer includes a polyolefin support structure and an ion conducting polymer at least partially penetrating the polyolefin support structure. A set of electrically conducting flow field plates are in communication with the first and second catalyst layers.

### TECHNICAL FIELD

The present invention relates to polyolefin supported ion conducting membranes for fuel cell applications.

### BACKGROUND

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”) to provide ion transport between the anode and cathode while also serving as an electrical insulator.

In proton exchange membrane type fuel cells, hydrogen is supplied to the anode as fuel, and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode layers of a typical PEM fuel cell are formed of porous conductive materials, such as woven graphite, graphitized sheets, or carbon paper to enable the fuel to disperse over the surface of the membrane facing the fuel supply electrode. Each electrode has finely divided catalyst particles (for example, platinum particles), supported on carbon particles, to promote oxidation of hydrogen at the anode and reduction of oxygen at the cathode. Protons flow from the anode through the ion conductive polymer membrane to the cathode where they combine with oxygen to form water which is discharged from the cell. Typically, the ion conductive polymer membrane includes a perfluorosulfonic acid (PFSA) ionomer.

The MEA is sandwiched between a pair of porous gas diffusion layers (“GDL”), which in turn are sandwiched between a pair of electrically conductive elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cells in stacks in order to provide high levels of electrical power.

Since a polyelectrolyte membrane must function as a proton conductor while at the same time serve as an electrical insulator, the dielectric properties of this membrane are highly relevant. The dielectric strength of a material is a measure of the electrical insulating properties of a material and is typically reported in kV/mm. This value indicates the voltage needed to cause electrical conduction through the material. In an operating fuel cell, the dielectric breakdown of a PEM results in catastrophic failures from electrical shorting and causes burn holes in both membranes and stainless steel plates. This failure mode is most apparent in membranes that have previously been run in fuel cells and which then later dry out during shut down and start-up operating conditions. Moreover, fuel cell reversal conditions are especially problematic. Polyelectrolyte membranes that have not yet been used in fuel cells typically do not show dielectric breakdown below 3 kV/mm. In contrast, a membrane previously used in a fuel cell shows dielectric breakdown between 0.1 and 0.2 kV/mm. Moreover, polyelectrolyte membranes are prone to suffer from electrical shorting after having been used in a fuel cell. This deficiency correlates to a durability failure mechanism in fuel cell systems. Porous polyethylene separators are presently being used to prevent shorting in lithium ion batteries by melting and shutting down ion conduction at hot spots.

Accordingly, there is a need for improved polyelectrolyte membranes exhibiting higher dielectric strength after being used in fuel cell systems.

### SUMMARY OF EXEMPLARY EMBODIMENTS OF THE INVENTION

The present invention solves one or more problems of the prior art by providing in at least one embodiment a fuel cell incorporating a polyolefin (e.g., polyethylene, polypropylene, poly(butylene), copolymers, terpolymers, and the like) supported ion conducting membrane. The fuel cell of this embodiment includes a first catalyst layer and a second catalyst layer. An ion conducting membrane is interposed between the first and second catalyst layers. Characteristically, the ion conducting layer includes a polyolefin (e.g., polyethylene) support structure and an ion conducting polymer at least partially penetrating the polyethylene support structure. A set of electrically conducting flow field plates are in communication with the first and second catalyst layers. Advantageously, the ion conducting membranes of this embodiment exhibit reduced dielectric breakdown and shorting.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 is a schematic illustration of a fuel cell that incorporates a gas diffusion layer of one or more embodiments of the invention;

FIG. 2 is a cross section of a composite membrane in the vicinity of a single void;

FIG. 3 is a scanning electron micrograph of a Tonen™ Supported Membrane;

FIGS. 4A, 4B, and 4C provide performance polarization curves for a 40-μm Tonen Supported Membrane and a Nafion® 50-μm membrane;

FIG. 5 provides an illustration showing the interpretation of dielectric breakdown testing; and

FIG. 6 provides results of the dielectric breakdown test on various membranes.

### DETAILED DESCRIPTION OF EXEMPLARY EMBODIMENTS

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

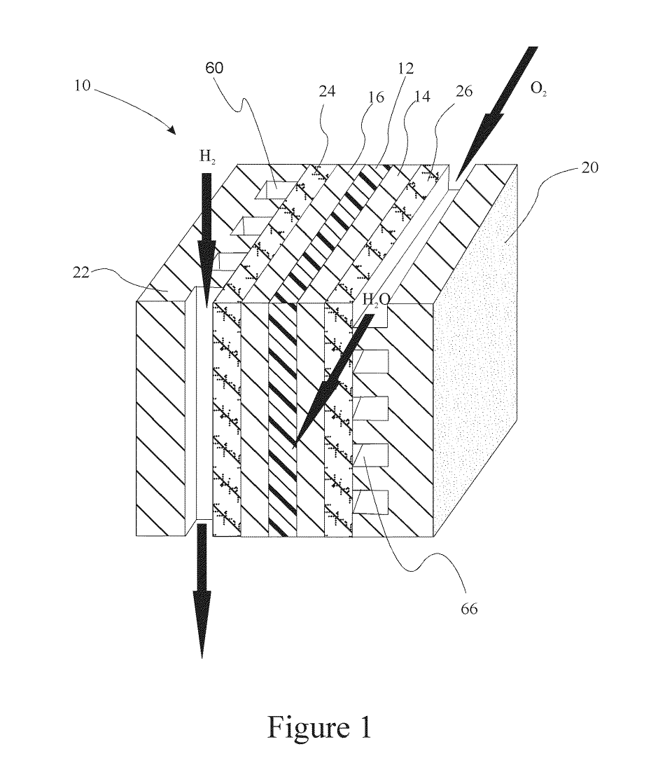

With reference to FIG. 1, a fuel cell that incorporates a polymeric ion conducting membrane is provided. PEM fuel cell 10 includes polymeric ion conducting membrane 12 disposed between cathode catalyst layer 14 and anode catalyst layer 16. Polymeric ion conducting composite membrane 12 includes one or more of the polymers set forth below. Fuel cell 10 also includes conductive plates 20, 22, gas channels 60 and 66, and gas diffusion layers 24 and 26. Advantageously, the present invention provides embodiments for ion conducting membrane 12.

Polymeric ion conducting membrane 12 includes a polyolefin support structure and an ion conducting polymer at least partially penetrating the polyolefin (e.g., polyethylene) support structure. In a variation of the present embodiment, the ion conducting polymer includes a plurality of protogenic groups. Protogenic groups are acidic moieties able to act as proton donors. In one refinement, the ion conducting polymer comprises a PFSA polymer. In another refinement, the ion conducting polymer comprises a perfluorocyclobutyl group.

Although the advantages of the present embodiment are not dependent on any particular mechanism, it is believed that the polyolefin support structure serves as a safety net which melts together and prevents electrical shorting from happening under conditions that would normally cause dielectric breakdown in fuel cell membranes. The present results are surprising because the polyolefin support structure still seems to prevent shorting from happening even though the pores of the polyolefin (polyethylene) matrix are filled with ionomer which may be expected to prevent the (polyolefin) polyethylene mesh from forming a continuous, electrically insulating dielectric layer.

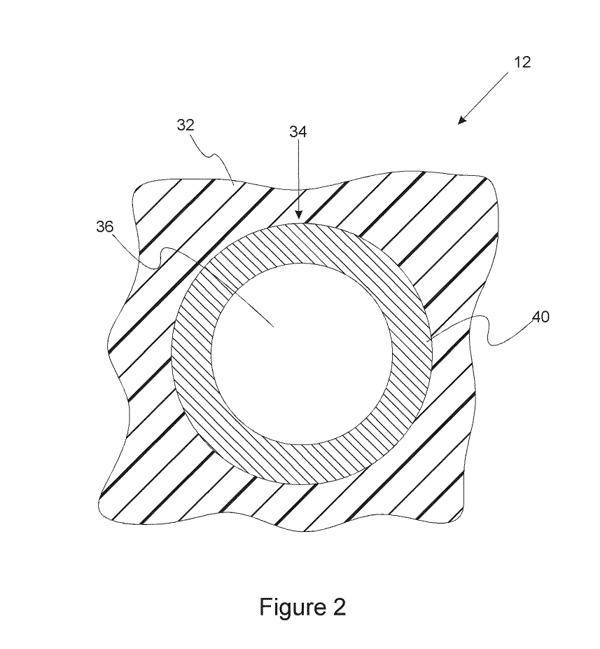

With reference to FIG. 2, a cross section of the composite membrane in the vicinity of a single void is provided. Composite membrane 12 includes support structure 32 having a predetermined void volume. Typically, the void volume is from 30 volume percent to 95 volume percent of the total volume of support structure 32. Support structure 32 is formed from a polyolefin. Examples of useful polyolefins include, but are not limited to, polyethylene, polypropylene, and the like. The details of ion conducting polymer 34 are set forth below. In a refinement, at least 50 percent of the void volume includes polymeric electrolyte composition 34, i.e., is filled with the polymeric electrolyte composition. Moreover, it should be appreciated that polymeric electrolyte composition 34 includes ion conducting polymers as well as optional additional polymers as set forth below.

Still referring to FIG. 2, composite membrane 12 is formed by contacting support structure 32 with a polymer-containing solution which includes a first polymer (the first polymer-containing solution) and an optional additive that inhibits polymeric degradation. In a refinement, the first polymer comprises the ion conducting polymer set forth above and explained below in more detail below. In a variation of the present embodiment, the first polymer-containing solution contains a sulfonated-perfluorocyclobutane polymer (PFSA) and a suitable solvent. In another variation, the first polymer-containing solution contains a PFSA polymer and a solvent. Examples of such solvents include alcohols, water, etc. In a refinement, the first polymer-containing solution comprises an ionomer in an amount from about 0.1 weight percent to about 5 weight percent of the total weight of the first polymer-containing solution. In another refinement, the first polymer-containing solution comprises an ionomer in an amount from about 0.5 weight percent to about 2 weight percent of the total weight of the first polymer-containing solution. The first polymer-containing solution penetrates into interior regions of support structure 32 such as void 36. At least a portion of the interior regions are coated with the first polymer-containing solution to form the first coated support structure. Polymer layer 40 comprises residues of the polymer-containing solution.

Examples of useful PFSAs are copolymers containing a polymerization unit based on a perfluorovinyl compound represented by:

CF₂═CF—(OCF₂CFX¹)ₘ—Oᵣ—(CF₂)_{q}—SO₃H

where m represents an integer of from 0 to 3, q represents an integer of from 1 to 12, r represents 0 or 1, and X¹ represents a fluorine atom or a trifluoromethyl group and a polymerization unit based on tetrafluoroethylene.

In one variation, the ion conducting polymer includes a cyclobutyl moiety. Suitable polymers having cyclobutyl moieties are disclosed in U.S. Pat. Pub. No. 2007/0099054, U.S. patent application Ser. No. 12/197,530 filed Aug. 25, 2008; 12/197,537 filed Aug. 25, 2008; 12/197,545 filed Aug. 25, 2008; and 12/197,704 filed Aug. 25, 2008; the entire disclosures of which are hereby incorporated by reference. In a variation, the ion conducting polymer has a polymer segment comprising polymer segment 1:

E₀-P₁-Q₁-P₂ 1

wherein:

Eₒ is a moiety having a protogenic group such as —SO₂X, —PO₃H₂, —COX, and the like;

P₁, P₂ are each independently: absent, —O—, —S—, —SO—, —CO—, —SO₂—, —NH—, NR₂—, or —R₃—;

R₂ is C₁₋₂₅ alkyl, C₁₋₂₅ aryl or C₁₋₂₅ arylene;

R₃ is C₁₋₂₅ alkylene, C₁₋₂₅ perfluoroalkylene, perfluoroalkyl ether, alkylether, or C₁₋₂₅ arylene;

X is an —OH, a halogen, an ester, or

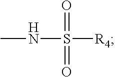

R₄ is trifluoromethyl, C₁₋₂₅ alkyl, C₁₋₂₅ perfluoroalkylene, C₁₋₂₅ aryl, or E₁ (see below); and

Q₁ is a fluorinated cyclobutyl moiety.

In variation of the present invention, the ion conducting polymer comprises polymer segments 2 and 3:

[E₁(Z₁)_{d}]-P₁-Q₁-P₂ 2

E₂-P₃-Q₂-P₄ 3

wherein:

Z₁ is a protogenic group such as —SO₂X, —PO₃H₂, —COX, and the like;

E₁ is an aromatic containing moiety;

E₂ is an unsulfonated aromatic-containing and/or aliphatic-containing moiety;

X is an —OH, a halogen, an ester, or

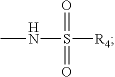

d is the number of Z₁ attached to E₁ (typically, d is 0, 1, 2, 3, or 4);

P₁, P₂, P₃, P₄ are each independently absent, —O—, —S—, —SO—, —CO—, —SO₂—, —NH—, NR₂—, or —R₃—;

R₂ is C₁₋₂₅ alkyl, C₁₋₂₅ aryl, or C₁₋₂₅ arylene;

R₃ is C₁₋₂₅ alkylene, C₁₋₂₅ perfluoroalkylene, perfluoroalkyl ether, alkylether, or C₁₋₂₅ arylene;

R₄ is trifluoromethyl, C₁₋₂₅ alkyl, C₁₋₂₅ perfluoroalkylene, C₁₋₂₅ aryl, or another E₁ group; and

Q₁, Q₂ are each independently a fluorinated cyclobutyl moiety.

In one refinement, d is equal to the number of aromatic rings in E₁. In another refinement, each aromatic ring in E₁ can have 0, 1, 2, 3, or 4 Z₁ groups.

In another variation of the present embodiment, the ion conducting polymer comprises segments 4 and 5:

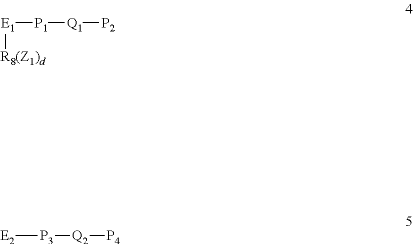

wherein:

Z₁ is a protogenic group such as —SO₂X, —PO₃H₂, —COX, and the like;

E₁, E₂ are each independently an aromatic-containing and/or aliphatic-containing moiety;

X is an —OH, a halogen, an ester, or

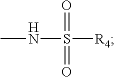

d is the number of Z₁ attached to R₈ (typically, d is 0, 1, 2, 3, or 4);

P₁, P₂, P₃, P₄ are each independently absent, —O—, —S—, —SO—, —CO—, —SO₂—, —NH—, NR₂—, or —R₃—;

R₂ is C₁₋₂₅ alkyl, C₁₋₂₅ aryl, or C₁₋₂₅ arylene;

R₃ is C₁₋₂₅ alkylene, C₁₋₂₅ perfluoroalkylene, perfluoroalkyl ether, alkylether, or C₁₋₂₅ arylene;

R₄ is trifluoromethyl, C₁₋₂₅ alkyl, C₁₋₂₅ perfluoroalkylene, C₁₋₂₅ aryl, or another E₁ group;

R₈(Z₁)_{d} is a moiety having d number of protogenic groups; and

Q₁, Q₂ are each independently a fluorinated cyclobutyl moiety.

In a refinement of this variation, R₈ is C₁₋₂₅ alkylene, C₁₋₂₅ perfluoroalkylene, perfluoroalkyl ether, alkylether, or C₁₋₂₅ arylene. In one refinement, d is equal to the number of aromatic rings in R₈. In another refinement, each aromatic ring in R₈ can have 0, 1, 2, 3, or 4 Z₁ groups. In still another refinement, d is an integer from 1 to 4 on average.

In another variation of the present embodiment, the ion conducting polymer comprises segments 6 and 7:

E₁(SO₂X)_{d}—P₁-Q₁-P₂ 6

E₂-P₃-Q₂-P₄ 7

connected by a linking group L₁ to form polymer units 8 and 9:

-(-E₂-P₃-Q₂-P₄—)ⱼ-L₁-(-E₁(SO₂X)_{d}—P₁-Q₁-P₂—)ᵢ- 8

-(-E₁(Z₁)_{d}—P₁-Q₁-P₂—)ᵢ-L₁-(-E₂-P₃-Q₂-P₄—)ⱼ- 9

wherein:

Z₁ is a protogenic group such as —SO₂X, —PO₃H₂, —COX, and the like;

E₁ is an aromatic-containing moiety;

E₂ is an unsulfonated aromatic-containing and/or aliphatic-containing moiety;

L₁ is a linking group;

X is an —OH, a halogen, an ester, or

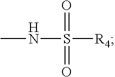

d is a number of Z₁ functional groups attached to E₁ (typically, d is 0, 1, 2, 3, or 4);

P₁, P₂, P₃, P₄ are each independently absent, —O—, —S—, —SO—, —SO₂—, —CO—, —NH—, NR₂—, —R₃—, and

R₂ is C₁₋₂₅ alkyl, C₁₋₂₅ aryl, or C₁₋₂₅ arylene;

R₃ is C₁₋₂₅ alkylene, C₁₋₂₅ perfluoroalkylene, or C₁₋₂₅ arylene;

R₄ is trifluoromethyl, C₁₋₂₅ alkyl, C₁₋₂₅ perfluoroalkylene, C₁₋₂₅ aryl, or another E₁ group;

Q₁, Q₂ are each independently a fluorinated cyclobutyl moiety;

i is a number representing the repetition of polymer segment 6 with i typically being from 1 to 200; and

j is a number representing the repetition of a polymer segment 7 with j typically being from 1 to 200. In one refinement, d is equal to the number of aromatic rings in E₁. In another refinement, each aromatic ring in E₁ can have 0, 1, 2, 3, or 4 Z₁ groups.

In still another variation of the present embodiment, the ion conducting polymer comprises polymer segments 10 and 11:

E₁(Z₁)_{d}—P₁-Q₁-P₂ 10

E₂(Z₁)_{f}—P₃ 11

wherein:

Z₁ is a protogenic group such as —SO₂X, —PO₃H₂, —COX, and the like;

E₁, E₂ are each independently an aromatic or aliphatic-containing moiety wherein at least one of E₁ and E₂ includes an aromatic containing moiety substituted with Z₁;

X is an —OH, a halogen, an ester, or

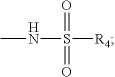

d is the number of Z₁ functional groups attached to E₁ (typically, d is 0, 1, 2, 3, or 4);

f is the number of Z₁ functional groups attached to E₂ (typically, f is 0, 1, 2, 3, or 4);

P₁, P₂, P₃ are each independently absent, —O—, —S—, —SO—, —SO₂—, —CO—, —NH—, NR₂—, or —R₃—;

R₂ is C₁₋₂₅ alkyl, C₁₋₂₅ aryl, or C₁₋₂₅ arylene;

R₃ is C₁₋₂₅ alkylene, C₁₋₂₅ perfluoroalkylene, perfluoroalkyl ether, alkyl ether, or C₁₋₂₅ arylene;

R₄ is trifluoromethyl, C₁₋₂₅ alkyl, C₁₋₂₅ perfluoroalkylene, C₁₋₂₅ aryl, or another E₁ group; and

Q₁ is a fluorinated cyclobutyl moiety,

with the proviso that when d is greater than zero, f is zero and when f is greater than zero, d is zero. In one refinement, d is equal to the number of aromatic rings in E₁. In another refinement, each aromatic ring in E₁ can have 0, 1, 2, 3, or 4 Z₁ groups. In still another refinement, d is an integer from 1 to 4 on average. In one refinement, f is equal to the number of aromatic rings in E₂. In another refinement, each aromatic ring in E₂ can have 0, 1, 2, 3, or 4 Z₁ groups. In still another refinement, f is an integer from 1 to 4 on average. In a variation, polymer segments 10 and 11 are each independently repeated 1 to 10,000 times to form respective polymer blocks that may be joined with a linking group L₁ shown below.

In still another variation of the present invention, the ion conducting polymer includes polymer segment 12:

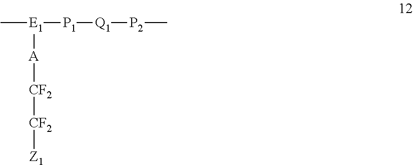

wherein:

Z₁ is a protogenic group such as —SO₂X, —PO₃H₂, or —COX, and the like;

E₁ is an aromatic containing moiety;

A is absent or O or a chain extender having a carbon backbone;

X is an —OH, a halogen, an ester, or

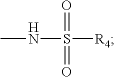

P₁, P₂ are each independently absent, —O—, —S—, —SO—, —SO₂—, —CO—, —NH—, NR₂—, or —R₃—;

R₂ is C₁₋₂₅ alkyl, C₁₋₂₅ aryl, or C₁₋₂₅ arylene;

R₃ is C₁₋₂₅ alkylene, C₁₋₂₅ perfluoroalkylene, or C₁₋₂₅ arylene;

R₄ is trifluoromethyl, C₁₋₂₅ alkyl, C₁₋₂₅ perfluoroalkylene, C₁₋₂₅ aryl, or another E₁ group; and

Q₁ is a fluorinated cyclobutyl moiety and in particular a perfluorocyclobutyl moiety.

In a refinement of this variation, A is an aromatic-containing moiety, an aliphatic-containing moiety, a polyether, a fluorinated polyether, and combinations thereof. In another refinement of the present embodiment, -ACF₂CF₂—Z₁ comprises a moiety having the following formula:

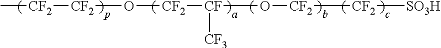

a, b, c, p are independently an integer from 1 to 10. In a refinement, p is 1, a is 0, b is 0, and c is 2. In another refinement, p is 0, a is 0, b is 0 and c is 2. In still another refinement, p is 1, a is 1, b is 0, and c is 2. In still another other refinement, p is 0, a is 0, b is 0, and c is 4. In yet another refinement, p is 0, a is 0, b is 0 and c is 1. In a variation, -ACF₂CF₂—Z₁ comprises:

Examples for Q₁ and Q₂ in the above formulae are:

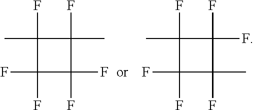

In each of the formulae 2-11, E₁ and E₂ include one or more aromatic rings. For example, E₁ and E₂, include one or more of the following moieties:

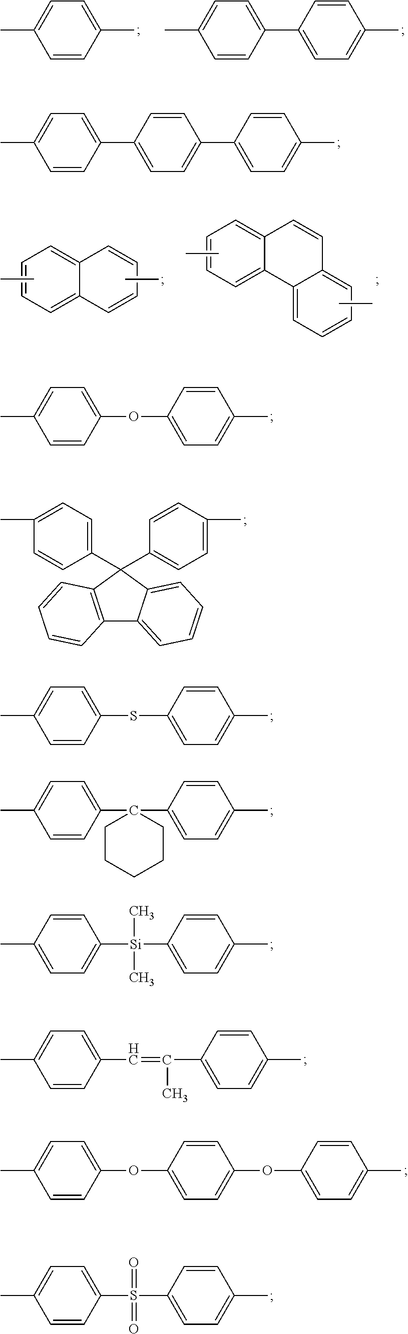

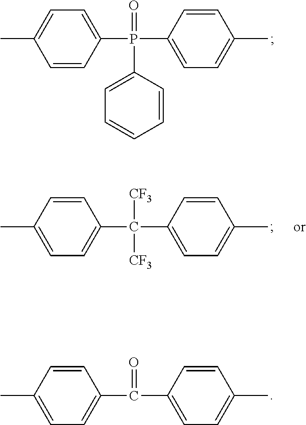

Examples of L₁ include the following linking groups:

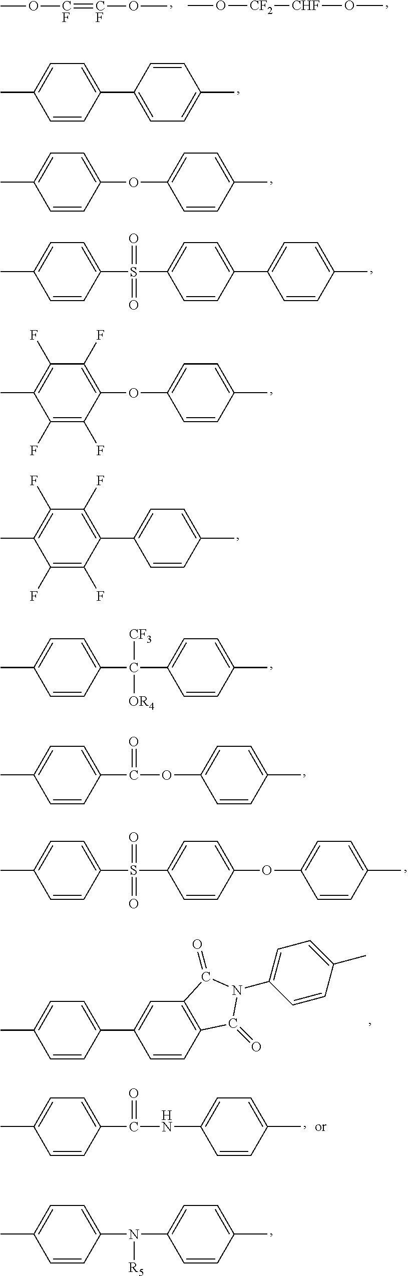

where R₅ is an organic group, such as an alkyl or acyl group.

In another embodiment, the ion conducting polymer is a perfluorosulfonic acid polymer (PFSA). In a refinement, such PFSAs are a copolymer containing a polymerization unit based on a perfluorovinyl compound represented by:

CF₂═CF—7(OCF₂CFX¹)ₘ—Oᵣ—(CF₂)_{q}—SO₃H

where m represents an integer of from 0 to 3, q represents an integer of from 1 to 12, r represents 0 or 1, and X¹ represents a fluorine atom or a trifluoromethyl group and a polymerization unit based on tetrafluoroethylene.

In yet another variation of the present invention, the ion conducting membrane also includes a non-ionic polymer such as a fluoro-elastomer that is mixed with the ion conducting polymer. The fluoro-elastomer may be any elastomeric material comprising fluorine atoms. The fluoro-elastomer may comprise a fluoropolymer having a glass transition temperature below about 25° C. or preferably, below 0° C. The fluoro-elastomer may exhibit an elongation at break in a tensile mode of at least 50% or preferably at least 100% at room temperature. The fluoro-elastomer is generally hydrophobic and substantially free of ionic groups. The fluoro-elastomer polymer chain may have favorable interaction with the hydrophobic domain of the second polymer described above. Such favorable interaction may facilitate formation of a stable, uniform and intimate blend of the two materials. The fluoro-elastomer may be prepared by polymerizing at least one fluoro-monomer such as vinylidene fluoride, tetrafluoroethylene, hexafluoropropylene, vinylfluoride, chlorotrifluoroethylene, perfluoromethylvinyl ether, and trifluoroethylene. The fluoro-elastomer may also be prepared by copolymerizing at least one fluoro-monomer and at least one non-fluoro-monomer such as ethylene, propylene, methyl methacrylate, ethyl acrylate, styrene, vinylchloride and the like. The fluoro-elastomer may be prepared by free radical polymerization or anionic polymerization in bulk, emulsion, suspension and solution. Examples of fluoro-elastomers include poly(tetrafluoroethlyene-co-ethylene), poly(vinyl id ene fluoride-co-hexafluoropropylene), poly(tetrafluoroethylene-co-propylene), terpolymer of vinylidene fluoride, hexafluoropropylene and tetrafluoroethylene, and terpolymer of ethylene, tetrafluoroethylene and perfluoromethylvinylether. Some of the fluoro-elastomers are commercially available from Arkema under trade name Kynar Flex® and Solvay Solexis® under the trade name Technoflon®, from 3M under the trade name Dyneon®, and from DuPont under the trade name Viton®. For example, Kynar Flex® 2751 is a copolymer of vinylidene fluoride and hexafluoropropylene with a melting temperature between about 130° C. and 140° C. The glass transition temperature of Kynar Flex® 2751 is about −40 to −44° C. The fluoro-elastomer may further comprise a curing agent to allow crosslinking reaction after being blended with the second polymer. In a refinement, the fluoro-elastomer is present in an amount from about in an amount from about 0.1 to about 40 weight percent of the ion conducting membrane.

In another variation of the present invention, the ion conducting polymer further includes an additive to improve stability. Examples of such additives include, but are not limited to, metal oxides. Examples of useful metal oxides include, but are not limited to, MnO₂, CeO₂, PtO₂, and RuO₂. Additional useful metal oxides are provided in U.S. Pat. Application No. 2008/0166620 filed Jul. 10, 2008, the entire disclosure of which is hereby incorporated by reference.

The following examples illustrate the various embodiments of the present invention. Those skilled in the art will recognize many variations that are within the spirit of the present invention and scope of the claims.

### EXPERIMENTAL

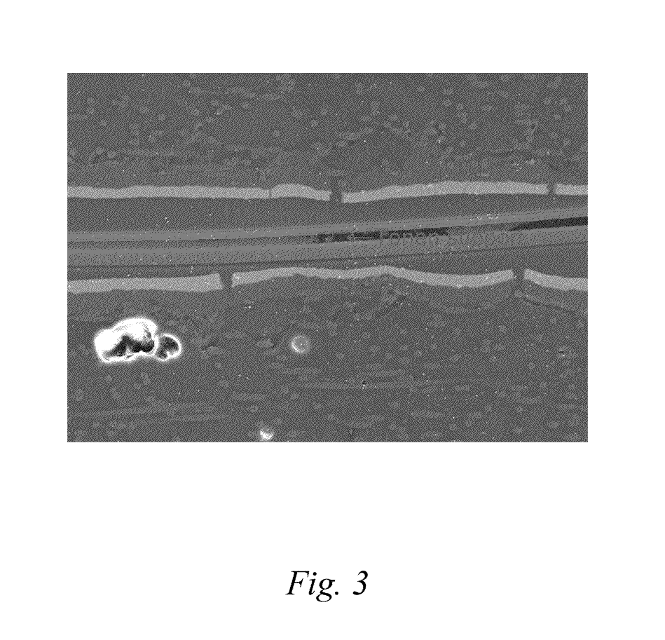

About 12 grams of DuPont DE2020 (20 wt. % Nafion 1000 in 1-propanol/water) are placed in an 8-inch×8-inch Pyrex glass baking dish. A piece of Tonen F10×02 polyethylene-polypropylene support (5-inch×5-inch) is placed in the glass dish, immersed in the perfluorosulfonic acid dispersion, and the air bubbles are rubbed out from underneath of the composite. Another upright glass dish are used to cover the dish containing the composite, which is then heated for 60 hours at 80° C. in a forced air oven. The composite is then floated off the glass dish with water. The dried Tonen composite film is about 40-micrometers thick. FIG. 3 provides a scanning electron microscopic cross-section of this membrane.

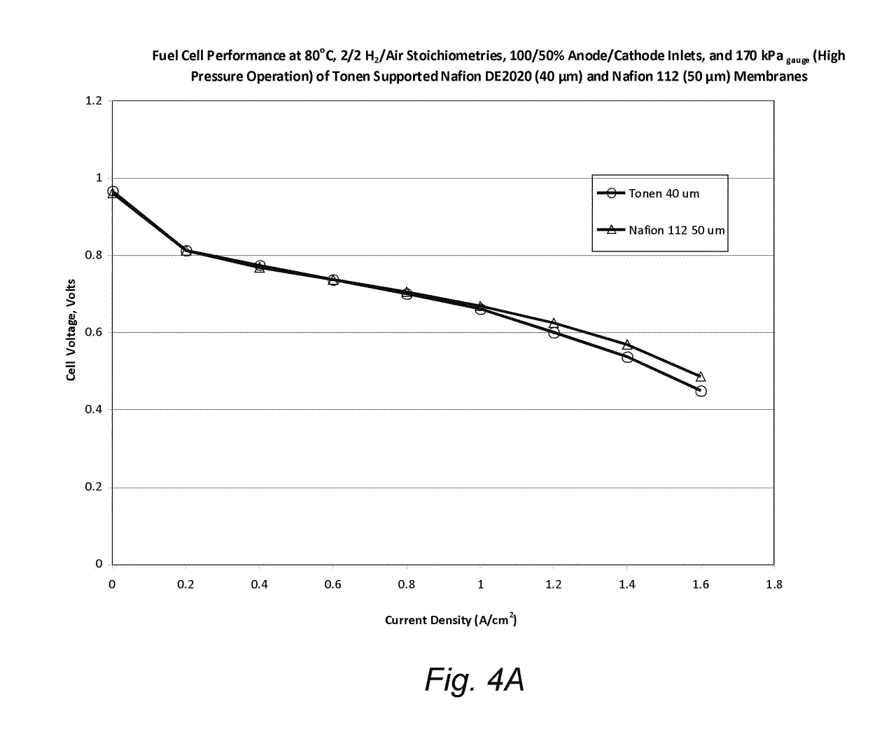

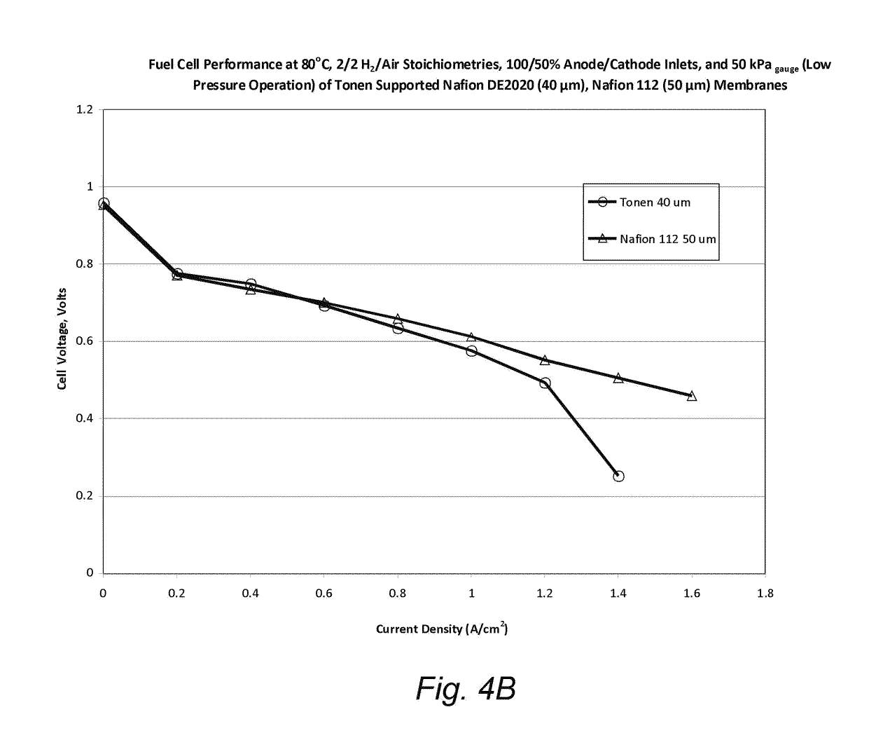

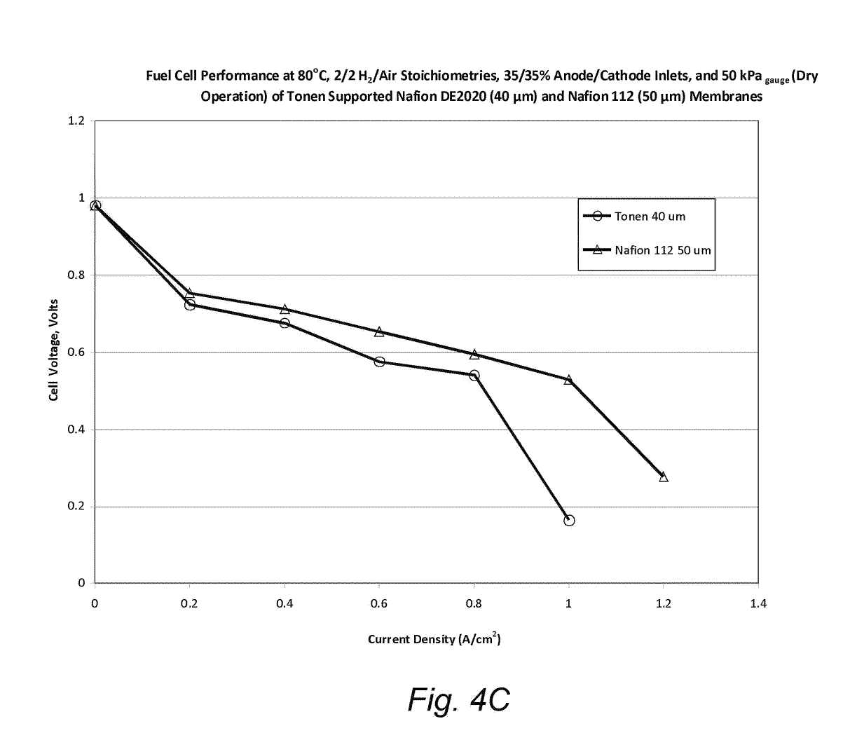

The transparent, 40-μm Tonen composite membrane is then tested in a fuel cell using 50-cm² hardware under wet, (80° C., 100% anode inlet relative humidity (“RH”)/50% cathode inlet RH, 170 kPa g, 2/2 H₂/air stoic.), moderate (80° C., 100% anode inlet RH/50% cathode inlet RH, 50 kPa g, 2/2 H₂/air stoic.), and dry (80° C., 35% anode inlet RH/35% cathode inlet RH, 50 kPa g, 2/2 H₂/air stoic.) humidity conditions using catalyst coated diffusion media with a micro-porous layer coating. Results were compared with those of a Nafion® 112 (50-μm membrane) evaluated as a catalyst coated membrane (see FIGS. 4A, 4B, and 4C).

FIGS. 4A, 4B, and 4C provide performance polarization curves of the 40-μm Tonen Supported Membrane and a Nafion® 112, 50-μm membrane. From a performance perspective, Tonen F10×02 which is imbibed with DE2020 (Nafion® 1000 eq. wt. ionomer) performed in fuel cell tests under wet, moderate and dry conditions. Under wet conditions, the Tonen composite performed within 50 mV of a propriety benchmark at 1 A/cm². Under moderate conditions, the Tonen composite was within 75 mV of the benchmark at 1 A/cm². Under dry conditions, the Tonen composite was substantially lower in performance than that of the Nafion® 112, 50-μm membrane. The proton conductivity of the Tonen composite versus % relative humidity measured at 80° C. was less than that of Nafion® 1000 alone.

Membranes that are fuel cell tested are evaluated for dielectric breakdown. The membranes are compressed between an anode and cathode flow field and are electrically stressed by applying direct voltage across the membrane. The test voltage is applied at a uniform rate of increase up to 5V. The direct voltage is obtained by a voltage power supply which limits the current if a dielectric breakdown occurs. The test procedure is as follows:

1) Install the membrane between an anode and cathode flow field and apply appropriate compression. The assembly is essentially a functioning fuel cell.

2) Flow dry nitrogen through both the cathode and anode flow field to remove moisture from the membrane and electrode. This is important to minimize the possibility of electrochemical reactions occurring when voltage is applied across the membrane. A standard purge time is about 10-15 minutes.

3) Attach a DC voltage power supply across the membrane. Increase voltage at a uniform rate from zero until dielectric breakdown occurs or 5V is reached. Use a rate of 65 mV/s. Limit power supply current to 3 Amps to limit damage if breakdown occurs.

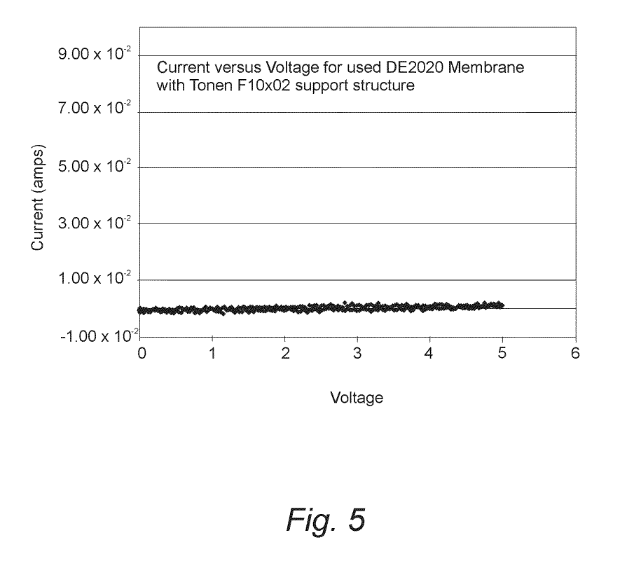

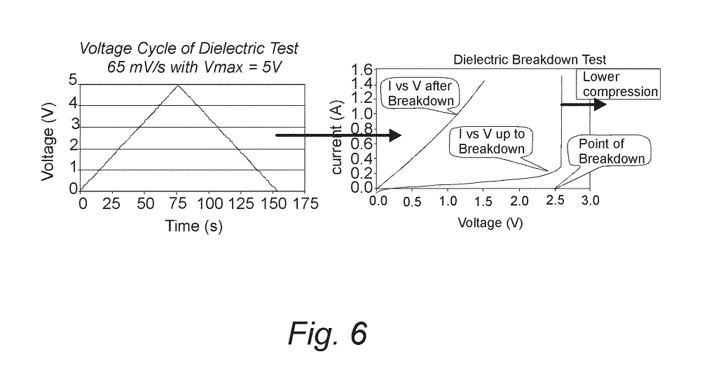

4) Dielectric breakdown is considered to occur when there is a rapid increase in current—see FIG. 5 or 6. Currents less than 0.2 A will exist for undamaged membranes.

FIG. 5 shows how results of the dielectric breakdown test are interpreted in which no dielectric breakdown occurs with the polyolefin supported Nafion® membrane. FIG. 6 shows the results of the dielectric breakdown test on Gore 5700™ 18-μm expanded polyetrafluoroethylene supported membrane which took place at 2.5 Volts and then when this membrane was re-tested after the dielectric breakdown had occurred (between 0-1.5 Volts). Polytetrafluoroethylene shows dielectric breakdown between 40 and 80 kV/mm. Membranes that are unused (i.e., as received) show a dielectric breakdown greater than 3 kV/mm, while membranes that are used in a fuel cell have dielectric breakdowns between 0.1 and 0.2 kV/mm.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A fuel cell comprising:
a first catalyst layer;
a second catalyst layer;
an ion conducting membrane interposed between the first and second catalyst layers, the ion conducting membrane comprising:
a polyolefin support structure;
an ion conducting polymer at least partially penetrating the polyolefin support structure; and
a set of electrically conducting flow field plates in communication with the first and second catalyst layers.

2. The fuel cell of claim 1 wherein the ion conducting polymer comprises a plurality of protogenic groups.

3. The fuel cell of claim 1 wherein the ion conducting polymer comprises a PFSA polymer.

4. The fuel cell of claim 1 wherein the ion conducting polymer comprises a perfluorocyclobutyl group.

5. The fuel cell of claim 1 wherein the ion conducting polymer is from about 30 weight percent to about 98 weight percent of the total weight of the ion conducting membrane.

6. The fuel cell of claim 1 wherein the polyolefin support structure has a void volume from 30 volume percent to 95 volume percent of the total volume of support structure.

7. The fuel cell of claim 1 wherein the polyolefin support structure comprises a component selected from the group consisting of polyethylene, polypropylene, polybutene, and combinations thereof.

8. The fuel cell of claim 1 wherein the ion conducting polymer comprises a polymer described by formula 1:
E₀-P₁-Q₁-P₂ 1
wherein:
Eₒ is a moiety having a protogenic group such as —SO₂X, —PO₃H₂, —COX, and the like;
P₁, P₂ are each independently: absent, —O—, —S—, —SO—, —CO—, —SO₂—, —NH—, NR₂—, or —R₃—;
R₂ is C₁₋₂₅ alkyl, C₁₋₂₅ aryl or C₁₋₂₅ arylene;
R₃ is C₁₋₂₅ alkylene, C₁₋₂₅ perfluoroalkylene, perfluoroalkyl ether, alkylether, or C₁₋₂₅ arylene;
X is an —OH, a halogen, an ester, or 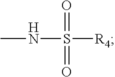
R₄ is trifluoromethyl, C₁₋₂₅ alkyl, C₁₋₂₅ perfluoroalkylene, C₁₋₂₅ aryl, or E₁ (see below); and
Q₁ is a fluorinated cyclobutyl moiety.

9. The fuel cell of claim 1 wherein the ion conducting polymer is a copolymer containing a polymerization unit based on a perfluorovinyl compound represented by:
CF₂═CF—(OCF₂CFX¹)ₘ—Oᵣ—(CF₂)_{q}—SO₃H
where m represents an integer of from 0 to 3, q represents an integer of from 1 to 12, r represents 0 or 1, and X¹ represents a fluorine atom or a trifluoromethyl group and a polymerization unit based on tetrafluoroethylene.

10. A fuel cell comprising:
a first catalyst layer;
a second catalyst layer;
an ion conducting membrane interposed between the first and second catalyst layers, the ion conducting layer comprising:
a polyolefin support structure;
an ion conducting polymer at least partially penetrating the polyolefin support structure; and
a set of electrically conducting flow field plates in communication with the first and second catalyst layers.

11. The fuel cell of claim 10 wherein the ion conducting polymer comprises a plurality of protogenic groups.

12. The fuel cell of claim 10 wherein the ion conducting polymer comprises a PFSA polymer.

13. The fuel cell of claim 10 wherein the ion conducting polymer comprises a perfluorocyclobutyl group.

14. The fuel cell of claim 10 wherein the polyolefin support structure has a void volume from 30 volume percent to 95 volume percent of the total volume of support structure.

15. An ion conducting membrane to be interposed between a first catalyst layer and a second catalyst layer in a fuel cell, the ion conducting membrane comprising:
a polyolefin support structure;
an ion conducting polymer at least partially penetrating the polyolefin support structure; and
a set of electrically conducting flow field plates in communication with the first and second catalyst layers.

16. The ion conducting membrane of claim 10 wherein the ion conducting polymer comprises a plurality of protogenic groups.

17. The ion conducting membrane of claim 10 wherein the ion conducting polymer comprises a PFSA polymer.

18. The ion conducting membrane of claim 10 wherein the ion conducting polymer comprises a perfluorocyclobutyl group.

19. The ion conducting membrane of claim 10 wherein the polyolefin support structure has a void volume from 30 volume percent to 95 volume percent of the total volume of support structure.

20. The ion conducting membrane of claim 1 wherein the polyolefin support structure comprises a component selected from the group consisting of polyethylene, polypropylene, polybutene, and combinations thereof.

21. The ion conducting membrane of claim 1 wherein the ion conducting polymer comprises a polymer described by formula 1:
E₀-P₁-Q₁-P₂ 1
wherein:
Eₒ is a moiety having a protogenic group such as —SO₂X, —PO₃H₂, —COX, and the like;
P₁, P₂ are each independently: absent, —O—, —S—, —SO—, —CO—, —SO₂—, —NH—, NR₂—, or —R₃—;
R₂ is C₁₋₂₅ alkyl, C₁₋₂₅ aryl or C₁₋₂₅ arylene;
R₃ is C₁₋₂₅ alkylene, C₁₋₂₅ perfluoroalkylene, perfluoroalkyl ether, alkylether, or C₁₋₂₅ arylene;
X is an —OH, a halogen, an ester, or 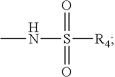
R₄ is trifluoromethyl, C₁₋₂₅ alkyl, C₁₋₂₅ perfluoroalkylene, C₁₋₂₅ aryl, or E₁ (see below); and
Q₁ is a fluorinated cyclobutyl moiety.
